(19) United States
(12) Patent Application Publication
(10) Pub. No.: US 2016/0098383 A1
(43) Pub. Date: Apr. 7, 2016

(54) Implicit Durations Calculation and Similarity Comparison in Question Answering Systems

(71) Applicant: International Business Machines Corporation, Armonk, NY (US)

(72) Inventors: David Contreras, Apex, NC (US); Robert C. Sizemore, Fuquay-Varina, NC (US); Sterling R. Smith, Apex, NC (US)

(21) Appl. No.: 14/507,919

(22) Filed: Oct. 7, 2014

(51) Int. Cl. G06F 17/24; G06F 19/00; G06F 17/28

(52) U.S. Cl. CPC G06F 17/241; G06F 17/28; G06F 19/322; G06F 19/345

(57) ABSTRACT

Mechanisms for performing a duration-based operation are provided. At least one document is received having a plurality of associated dates and/or times and concepts associated with the dates and/or times. The at least one document does not explicitly specify a duration between the dates and/or times. Dates and/or times in the at least one document having similar associated concepts are correlated and, for the correlated dates and/or times, an implicit duration is calculated based on the dates and/or times. The concepts are associated with the implicit duration and a first document in the at least one document is annotated with an implicit duration annotation that specifies the implicit duration and the associated concepts. A duration based operation is then performed based on the implicit duration annotation.

### BACKGROUND

The present application relates generally to an improved data processing apparatus and method and more specifically to mechanisms for performing implicit duration calculations and similarity comparisons in question answering systems.

With the increased usage of computing networks, such as the Internet, humans are currently inundated and overwhelmed with the amount of information available to them from various structured and unstructured sources. However, information gaps abound as users try to piece together what they can find that they believe to be relevant during searches for information on various subjects. To assist with such searches, recent research has been directed to generating Question and Answer (QA) systems which may take an input question, analyze it, and return results indicative of the most probable answer to the input question. QA systems provide automated mechanisms for searching through large sets of sources of content, e.g., electronic documents, and analyze them with regard to an input question to determine an answer to the question and a confidence measure as to how accurate an answer is for answering the input question.

Examples, of QA systems are Siri® from Apple®, Cortana® from Microsoft®, and the Watson™ system available from International Business Machines (IBM®) Corporation of Armonk, N.Y. The Watson™ system is an application of advanced natural language processing, information retrieval, knowledge representation and reasoning, and machine learning technologies to the field of open domain question answering. The Watson™ system is built on IBM's DeepQA™ technology used for hypothesis generation, massive evidence gathering, analysis, and scoring. DeepQA™ takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

### SUMMARY

In one illustrative embodiment, a method, in a data processing system comprising a processor and a memory, for performing a duration-based operation is provided. The method comprises receiving, by the data processing system, at least one document having a plurality of associated dates and/or times and concepts associated with the dates and/or times. The at least one document does not explicitly specify a duration between the dates and/or times. The method further comprises correlating, by the data processing system, dates and/or times in the at least one document having similar associated concepts and calculating, by the data processing system, for the correlated dates and/or times, an implicit duration based on the dates and/or times. In addition, the method comprises associating, by the data processing system, the associated concepts with the implicit duration and annotating, by the data processing system, a first document in the at least one document with an implicit duration annotation that specifies the implicit duration and the associated concepts. Moreover, the method comprises performing, by the data processing system, the duration-based operation based on the implicit duration annotation.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a question/answer creation (QA) system in a computer network;

FIG. 2 is a block diagram of an example data processing system in which aspects of the illustrative embodiments are implemented;

FIG. 3 illustrates a QA system pipeline for processing an input question in accordance with one illustrative embodiment;

FIG. 4 is an example medical policy and patient clinical history, as may be provided in an electronic patient medical record for example, in accordance with one illustrative embodiment; and

FIG. 5 is a flowchart outlining an example operation of a QA system implementing an implicit duration annotation mechanism in accordance with one illustrative embodiment.

### DETAILED DESCRIPTION

The illustrative embodiments provide mechanisms for performing implicit duration calculations and similarity comparisons. Moreover, the mechanisms of the illustrative embodiments utilize such implicit duration calculations and similarity comparisons for purposes of answering questions using a Question Answering (QA) system, such as the IBM Watson™ QA system available from International Business Machines (IBM) Corporation of Armonk, N.Y., or otherwise providing knowledge and recommendations based on a knowledge system operation.

Often documents have dates and times associated with them and may specify events, conditions, and the like, which have dates and times associated with them. For example, in the medical domain, doctors often make clinical notes regarding the patients that they treat, the clinical notes serve as a patient medical history specifying the symptoms experienced by the patient, the illnesses with which the patient is diagnosed, medications and treatments administered or prescribed to the patient, and the like. These clinical notes generally have dates and times associated with them. While there are explicit dates/times associated with such notes, durations are not generally explicitly stated in such documents, clinical notes, etc. To the contrary, durations are implicit in nature, leaving it to the reader to determine for themselves what the duration is by evaluating multiple dates/times for multiple documents, notes or entries in the documents, etc. However, durations may be important to know in order to make decisions, answer questions, and the like. For example, in the medical domain, medical policies are generally dependent upon duration of an illness, time the patient has been utilizing a particular treatment, medication, or has had some type of medical intervention.

The implicit nature of durations in such documents can be problematic with automated systems since it is not always readily apparent which dates/times are related to one another such that a duration may be determined. As such, in knowledge systems utilizing natural language processing, such as a QA system or the like, the knowledge systems do not take into account dates in different sections of a document or create an association of concepts such that implicit durations may be utilized as a basis for performing intelligent processing.

The illustrative embodiments provide automated mechanisms for analyzing dates/times in different portions of one or more documents, as well as their associated text, utilizing natural language processing techniques, to calculate implicit durations in the documents Annotations are added to the documents to specify these calculated implicit durations, i.e. durations that are not explicitly stated in the documents but may be inferred from the dates/times specified in different portions of the document or documents. The annotations correlate the calculated implicit durations with particular associated concepts identified from the natural language text of the document. These annotations may then be used by the knowledge system, e.g., a QA system, to perform duration similarity comparisons when needed to make decisions, recommendations, or provide information to a user in response to a request from the user, e.g., a question submitted by a user to the QA system.

For purposes of the following description, it will be assumed that the mechanisms of the illustrative embodiments operate in a medical domain and operate on patient history documents, e.g., electronic medical records (EMRs), comprising clinical notes of one or more doctors, physicians, nurses, or other medical personnel. While the illustrative embodiments will be described in the context of a medical domain, it should be appreciated that this is only an example and the present invention is not limited to any particular domain. To the contrary, the illustrative embodiments may be utilized with any domain in which durations may be implicit in the documentation of the particular domain such that the mechanisms of the illustrative embodiments may be utilized to calculate the implicit durations and utilize them for purposes of duration similarity comparisons such that knowledge system operations, decisions, and the like may be made.

In one illustrative embodiment, a QA system is provided for answering questions regarding the medical condition, treatment, or the like, of patients based on their patient medical histories or EMRs. For example, the QA system may process the patient medical history to investigate the dates/times associated with clinical notes in the patient's medical history and calculate implicit durations and corresponding concepts from the patient's medical history. These implicit durations and corresponding concepts may be compared to medical policies to determine whether particular medical policies corresponding to the concepts are triggered based on the calculated implicit duration. For example, if it is determined that a patient has been receiving medication X for at least 3 weeks (determined from a date/time on a clinical note indicating the start of the treatment and a date/time on a clinical note indicating that the patient is still taking the medication X on a day at least 3 weeks later), a medical policy may state that if the mediation X has been used for 3 weeks and the patient is still experiencing the symptoms, then medication Y should be started. Thus, as a result of the comparison of the calculated implicit duration of 3 weeks to the duration in the medical policy, a corresponding recommendation for further treatment of the patient may be generated and output by the QA system. This will be described in greater detail hereafter.

As noted above, while the illustrative embodiments will assume that the mechanisms operate on documents that are patient medical histories and medical policy documents, the illustrative embodiments in other domains may operate on other types of documents in which dates/times that indicate implicit durations may be provided. It should be appreciated that the term “document” as it is used herein refers to any portion of text, provided in an electronic manner, that may be processed using a natural language processing technique to extract facts and meaning from the text. As such, a “document” may be a single sentence, a paragraph, a few paragraphs, multiple pages of text, an entire book or multi-page document, or the like. The “documents” may be provided in many different electronic forms including being provided as document files, webpages, individual posts to webpages or on-line forums, portions of text stored in a database, or any other form of electronic/data representation of text.

Before beginning a more detailed discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the illustrative embodiments may be implemented in, or in association with, a knowledge system such as a QA system or the like, so as to provide functionality for calculating durations that are implicitly present in documentation so as to annotate the documentation with explicit identifications of the durations and their associated concepts. The mechanisms of the illustrative embodiments further utilize the annotations to facilitate decision making, question answering, information retrieval and presentation, and the like. Thus, the illustrative embodiments may be utilized in many different types of data processing environments providing knowledge systems utilizing natural language processing. For purposes of the following description, it will be assumed for example purposes only, that the present invention is implemented in, or in association with, a QA system and are used to generate answers to submitted questions. It should be appreciated that the present invention may be used with other types of knowledge systems without departing from the spirit and scope of the illustrative embodiments.

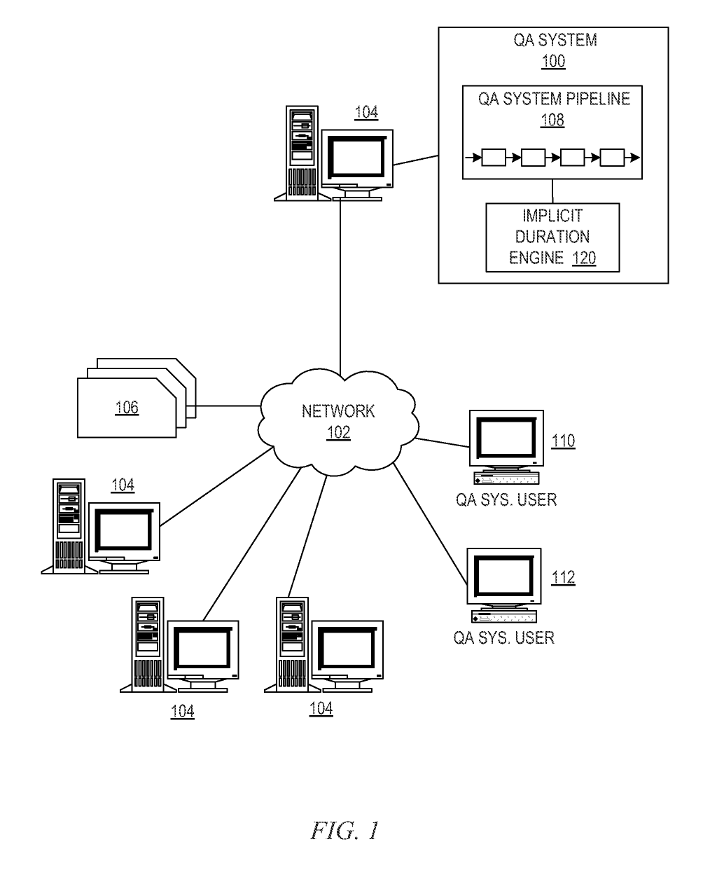

In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIGS. 1-3 are directed to describing an example Question Answering (QA) system (also referred to as a Question/Answer system or Question and Answer system), methodology, and computer program product with which the mechanisms of the illustrative embodiments are implemented. As will be discussed in greater detail hereafter, the illustrative embodiments are integrated in, augment, and extend the functionality of these QA mechanisms with regard to implicit duration identification, duration calculations and annotation of documents, and implicit duration based question answering or other knowledge based decisions and operations. While a QA system will be used in the following description of example illustrative embodiments, it should be appreciated that the mechanisms of the illustrative embodiments may be employed in any data processing system implementing natural language processing in which evaluation of implied durations is of use in presenting information, making decisions, generating recommendations, or the other higher level logical processing.

Thus, it is important to first have an understanding of how question and answer creation in a QA system is implemented before describing how the mechanisms of the illustrative embodiments are integrated in and augment such QA systems. It should be appreciated that the QA mechanisms described in FIGS. 1-3 are only examples and are not intended to state or imply any limitation with regard to the type of QA mechanisms with which the illustrative embodiments are implemented. Many modifications to the example QA system shown in FIGS. 1-3 may be implemented in various embodiments of the present invention without departing from the spirit and scope of the present invention.

As an overview, a Question Answering system (QA system) is an artificial intelligence application executing on data processing hardware that answers questions pertaining to a given subject-matter domain presented in natural language. The QA system receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA system. The document may include any file, text, article, or source of data for use in the QA system. For example, a QA system accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to the QA system which then answers the input questions using the content in the corpus of data by evaluating documents, sections of documents, portions of data in the corpus, or the like. When a process evaluates a given section of a document for semantic content, the process can use a variety of conventions to query such document from the QA system, e.g., sending the query to the QA system as a well-formed question which are then interpreted by the QA system and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA system receives an input question, parses the question to extract the major features of the question, uses the extracted features to formulate queries, and then applies those queries to the corpus of data. Based on the application of the queries to the corpus of data, the QA system generates a set of hypotheses, or candidate answers to the input question, by looking across the corpus of data for portions of the corpus of data that have some potential for containing a valuable response to the input question. The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model is used to summarize a level of confidence that the QA system has regarding the evidence that the potential response, i.e. candidate answer, is inferred by the question. This process is repeated for each of the candidate answers until the QA system identifies candidate answers that surface as being significantly stronger than others and thus, generates a final answer, or ranked set of answers, for the input question.

As mentioned above, QA systems and mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA system to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA system. Content creators, automated tools, or the like, annotate or otherwise generate metadata for providing information useable by the QA system to identify these question and answer attributes of the content.

Operating on such content, the QA system generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 1 depicts a schematic diagram of one illustrative embodiment of a question/answer creation (QA) system 100 in a computer network 102. One example of a question/answer generation which may be used in conjunction with the principles described herein is described in U.S. Patent Application Publication No. 2011/0125734, which is herein incorporated by reference in its entirety. The QA system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The QA system 100 and network 102 enables question/answer (QA) generation functionality for one or more QA system users via their respective computing devices 110-112. Other embodiments of the QA system 100 may be used with components, systems, sub-systems, and/or devices other than those that are depicted herein.

The QA system 100 is configured to implement a QA system pipeline 108 that receive inputs from various sources. For example, the QA system 100 receives input from the network 102, a corpus of electronic documents 106, QA system users, and/or other data and other possible sources of input. In one embodiment, some or all of the inputs to the QA system 100 are routed through the network 102. The various computing devices 104 on the network 102 include access points for content creators and QA system users. Some of the computing devices 104 include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 includes local network connections and remote connections in various embodiments, such that the QA system 100 may operate in environments of any size, including local and global, e.g., the Internet.

In one embodiment, the content creator creates content in a document of the corpus of data 106 for use as part of a corpus of data with the QA system 100. The document includes any file, text, article, or source of data for use in the QA system 100. QA system users access the QA system 100 via a network connection or an Internet connection to the network 102, and input questions to the QA system 100 that are answered by the content in the corpus of data 106. In one embodiment, the questions are formed using natural language. The QA system 100 parses and interprets the question, and provides a response to the QA system user, e.g., QA system user 110, containing one or more answers to the question. In some embodiments, the QA system 100 provides a response to users in a ranked list of candidate answers while in other illustrative embodiments, the QA system 100 provides a single final answer or a combination of a final answer and ranked listing of other candidate answers.

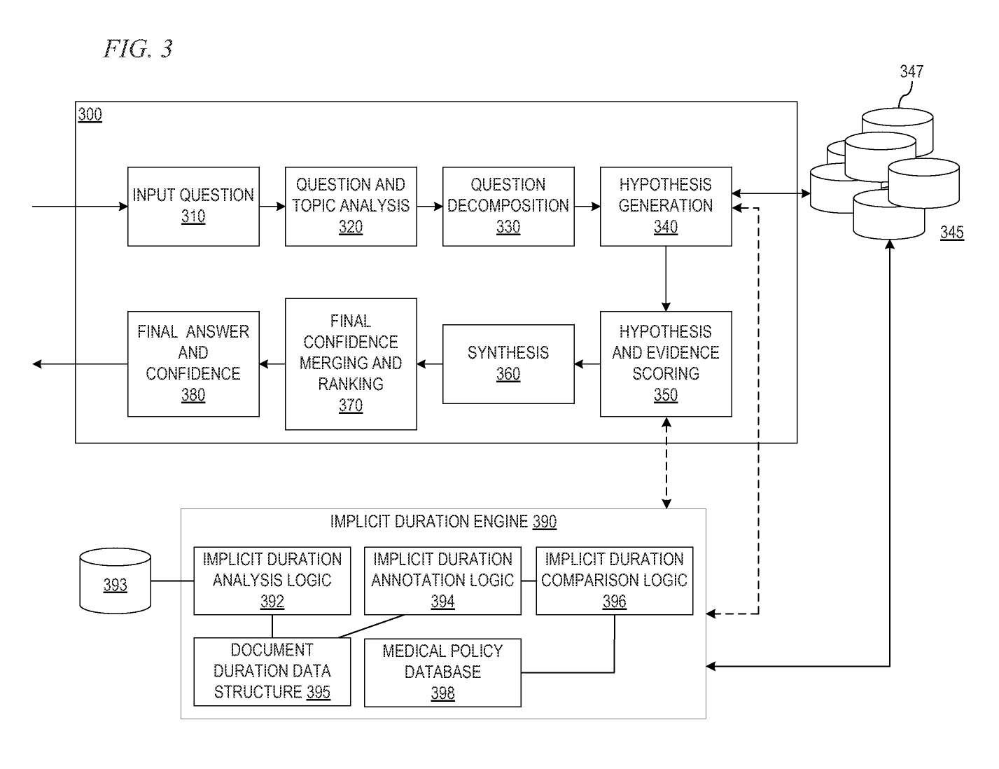

The QA system 100 implements a QA system pipeline 108 which comprises a plurality of stages for processing an input question and the corpus of data 106. The QA system pipeline 108 generates answers for the input question based on the processing of the input question and the corpus of data 106. The QA system pipeline 108 will be described in greater detail hereafter with regard to FIG. 3.

In some illustrative embodiments, the QA system 100 may be the IBM Watson™ QA system available from International Business Machines Corporation of Armonk, N.Y., which is augmented with the mechanisms of the illustrative embodiments described hereafter. As outlined previously, the IBM Watson™ QA system receives an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The IBM Watson™ QA system then performs deep analysis on the language of the input question and the language used in each of the portions of the corpus of data found during the application of the queries using a variety of reasoning algorithms. The scores obtained from the various reasoning algorithms are then weighted against a statistical model that summarizes a level of confidence that the IBM Watson™ QA system has regarding the evidence that the potential response, i.e. candidate answer, is inferred by the question. This process is be repeated for each of the candidate answers to generate ranked listing of candidate answers which may then be presented to the user that submitted the input question, or from which a final answer is selected and presented to the user. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

As shown in FIG. 1, with particular importance to the mechanisms of the illustrative embodiments, the QA system 100 further comprises an implicit duration engine 120 that operates in conjunction with the QA system pipeline 108. In operating with the QA system pipeline 108, the implicit duration engine 120 operates on the corpus or corpora of documents associated with the QA system pipeline 108, during ingestion of the corpus or corpora or as a pre-processor prior to ingestion, to analyze the documents and identify implicit durations within, and between, these documents along with the corresponding concepts associated with these implicit durations, e.g., administration of a treatment (concept) for a medical condition (concept) being provided for one month (duration) as implicitly defined by the specification of multiple dates/times within, or between, the documents. These implicit durations are identified and the actual duration is calculated and made explicit through annotation of the documents in the corpus or corpora which associates the calculated duration with the concepts identified in the natural language documents of the corpus or corpora and makes these explicit in the annotation metadata associated with the documents.

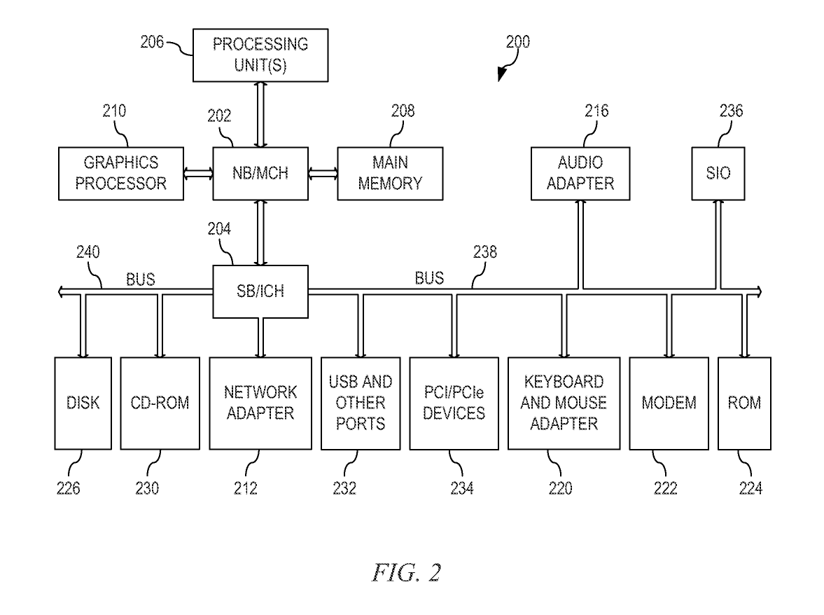

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a QA system 100 and QA system pipeline 108 augmented to include the additional mechanisms of the illustrative embodiments described hereafter.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 8®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System P® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 illustrates a QA system pipeline for processing an input question in accordance with one illustrative embodiment. The QA system pipeline of FIG. 3 may be implemented, for example, as QA system pipeline 108 of QA system 100 in FIG. 1. It should be appreciated that the stages of the QA system pipeline shown in FIG. 3 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA system pipeline of FIG. 3 is augmented, for example, in one or more of the stages to implement the improved mechanism of the illustrative embodiments described hereafter, additional stages may be provided to implement the improved mechanism, or separate logic from the pipeline 300 may be provided for interfacing with the pipeline 300 and implementing the improved functionality and operations of the illustrative embodiments.

As shown in FIG. 3, the QA system pipeline 300 comprises a plurality of stages 310-380 through which the QA system operates to analyze an input question and generate a final response. In an initial question input stage 310, the QA system receives an input question that is presented in a natural language format. That is, a user inputs, via a user interface, an input question for which the user wishes to obtain an answer, e.g., “Who are Washington's closest advisors?” In response to receiving the input question, the next stage of the QA system pipeline 300, i.e. the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 3, the identified major features are then used during the question decomposition stage 330 to decompose the question into one or more queries that are applied to the corpora of data/information 345 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 345. That is, these various sources themselves, different collections of sources, and the like, represent a different corpus 347 within the corpora 345. There may be different corpora 347 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 347 within the corpora 345.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 340 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA system pipeline 300, in stage 350, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA system and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA system that identifies a manner by which these scores may be combined to generate a confidence score or measure for the individual hypotheses or candidate answers. This confidence score or measure summarizes the level of confidence that the QA system has about the evidence that the candidate answer is inferred by the input question, i.e. that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, are generated and output to the submitter of the original input question via a graphical user interface or other mechanism for outputting information.

As discussed above, the illustrative embodiments augment the operation of the QA system pipeline 300 with the additional functionality of the implicit duration engine, which is shown in FIG. 3 as implicit duration engine 390. The implicit duration engine 390 comprises document implicit duration analysis logic 392, document duration annotation logic 394, and duration comparison logic 396. In addition, the implicit duration engine 390 includes, or operates in concert with, a policy database which, in this example implementation, is a medical policy database 398. The implicit duration engine 390 works in conjunction with various stages of the QA system pipeline, such as stages 340 and 350, to assist in the generation of candidate answers to an input question 310 by evaluating implicit durations in documents (made explicit through the operation of the implicit duration engine 390) and comparing the implicit durations to criteria for generation of candidate answers as described hereafter. It should be appreciated that while FIG. 3 illustrates the duration comparison logic 396 and medical policy database 398 as being part of the implicit duration engine 390, this logic may be integrated into the logic of other stages of the QA system pipeline 300, such as hypothesis generation stage 340, hypothesis and evidence scoring stage 350, or the like, without departing from the spirit and scope of the illustrative embodiments.

The implicit duration engine 390 receives a document, or collection of related documents, for processing, such as part of a corpus 347 or corpora 345 ingestion operation of the QA system. The document is analyzed by the implicit duration analysis logic 392 to identify dates/times associated with the document as a whole, e.g. publication dates/times, creation dates/times, dates/times mentioned in the content of the document, or the like. These dates/times may be identified via pattern matching, keyword identification, metadata analysis, or any other method of identify a string of alphanumeric characters indicative of a date/time. Natural language processing is performed by the implicit duration analysis logic 392 on the text associated with the dates/times identified in the document to identify concepts associated with those dates/times. For example, concepts in text that are in close proximity to the date/time, e.g., within a predetermined number of words, sentences, paragraphs, etc., or that is pointed to by the date/time (in the case of dates/times being provided in metadata linked to particular text within the document), are identified and associated with the date/time. In one illustrative embodiment, the natural language processing in this regard may make use of domain-specific resources 393, such as domain-specific dictionaries, synonym databases, and other reference data structures that facilitate the identification of words and phrases within the text that are indicative of domain-specific concepts. These domain specific resources 393 may be part of the implicit duration engine 390 or may be separate from the implicit duration engine 390 (as shown) and in some cases may be resources used by the QA system pipeline 300 when processing the input question 310 in the manner described above.

In one example, the domain-specific resources 393 are specific to a medical domain, and may be specific to a particular type of medical domain, e.g., oncology, podiatry, cardiology, etc. For example, with a medical domain, the domain-specific resources 393 may comprise a dictionary of medical terms/phrases, e.g., the terms “renal”, “autoimmune”, “carcinoma”, and a plethora of other terms/phrases in the medical domain, which may be used to match to terms/phrases in text of documents to identify concepts. Similarly, synonym databases may be established and utilized for the particular medical domain such that terms/phrases that are synonyms of the terms/phrases in the domain-specific dictionary may be identified and related to the domain-specific dictionary terms/phrases, e.g., “renal failure” and “kidney failure” may be considered synonyms of each other.

In one illustrative embodiment, the documents that are processed by the implicit duration engine 390 are patient medical records that specify patient medical histories listing out the patient symptoms, medical diagnosis, and treatments that the patient has experienced over time. These patient medical histories may comprise clinical notes made by health care professionals, e.g., doctors, nurses, medical technicians, and the like, during the treatment of the patient for one or more various medical conditions. The clinical notes generally have a date/time associated with them and specify the particular symptoms, diagnosis, and the treatment prescribed for the diagnosis. It should be appreciated that this is but one example of the documents that may be processed by the mechanisms of the illustrative embodiments and is not intended to be limiting on the scope of the present invention.

Each date/time identified in the document(s) may have one or more concepts associated with it as extracted from the text related to the date/time by way of the natural language processing. For example, assuming that the document is a patient's medical record, an entry in the medical record may be of the type “10.14.14 Patient complains of abdominal pain; prescribed laxative and ordered x-ray”. From this entry in the patient's medical record, the date/time of “10.14.14” may be identified, which may have other formats as determined and identifiable by the implicit duration engine 390, e.g., “14.10.14,” “Oct. 14, 2014,” “14 Oct. 2014,” “Oct. 14, 2014,” and the like, and the corresponding concepts extracted from the text using natural language processing may include “abdominal pain,” “laxative,” and “x-ray,” for example.

Multiple such dates/times and corresponding concepts may be identified in a document, or from a collection of documents, so that these multiple date/time entries may be compared to identify related dates/times that are indicative of an implicit duration. For example, assume that a subsequent entry is made to the patient's medical record of “10.21.14 Patient continues to complain of abdominal pain; patient is still taking laxative; x-ray results are negative.” From this entry in the patient's medical record, another date/time and corresponding concepts entry may be generated that indicates the date/time of “10.21.14” with corresponding concepts of “abdominal pain,” “laxative,” “x-ray”, and “results are negative.” It should be appreciated that other documents related to the document in question may also be processed in this manner, e.g., radiology reports, laboratory test result documents, etc., so as to obtain a complete understanding of the events and conditions present at various dates/times.

For example, in the above scenario, reports made for the same patient from a x-ray technician or radiologist may be correlated with the patient medical record to obtain an entry of the type “Oct. 14, 2014: x-ray of patient shows no obstructions of abdominal cavity; no other indications of possible cause of abdominal pain; results negative.” In such a situation, the implicit duration engine 390 may analyze this entry in another document and correlate it with the entries obtained from the patient medical record to generate a combined and correlated document duration data structure 395 in memory of the implicit duration engine 390 that indicates the overall dates/times and related concepts obtained from the related documents, e.g., in this case another entry with the date/time 10.14.14 in which the concepts of “no obstructions,” “abdominal cavity,” “abdominal pain,” and “results negative” is generated.

It should be appreciated that, in this scenario, there is no explicit time duration indicated in the patient's medical record for how long the patient has been experiencing the medical condition or how long the patient has been undergoing the particular treatment, e.g., taking of laxatives in this example. To the contrary, only a listing of clinical notes with the corresponding dates/times of the clinical notes is provided. Thus, it is difficult for automated systems to process such documents and apply policies that are duration based policies since the durations are not explicitly stated in the documents themselves. For example, if a medical policy is in place that states that “If abdominal pain persists after 5 days of laxative treatment, perform MRI on patient,” it is difficult for knowledge systems to determine whether the policy is applicable to a particular situation when the duration (5 days) is not explicitly stated in the input data.

Having identified date/times in the document(s) in question, and their corresponding concepts, to generate a document duration data structure 395, the implicit duration annotation logic 394 operates on the document duration data structure 395 to calculate date/time durations associated with the documents. In performing such calculations, the implicit duration annotation logic 394 identifies entries in the document duration data structure 395 that have similar concepts and scores these entries according to their level of similarity. For example, the terms/phrases representative of the concepts associated with the dates/times in the entries of the document duration data structure 395 are compared, taking into consideration synonyms and the like, and a degree of similarity is calculated based on the amount of matching of the terms/phrases. Using the above scenario as an example, the initial entry for Oct. 14, 2014 having related concepts of “abdominal pain,” “laxative,” and “x-ray,” would have a relatively high confidence score (indicating high confidence that the entries are related) when compared to the subsequent entry for Oct. 21, 2014 with related concepts of “abdominal pain,” “laxative,” “x-ray”, and “results are negative.” That is, since all of the concepts in the first entry also appear in the second entry, there is a strong relationship between the entries indicative of the entries representing a same series of events or conditions. As a result, these entries are identified and correlated as being related to one another. Another entry of the type “11.15.14 Patient complains of eye strain; referred patient to ophthalmologist” would have a relatively low confidence score (indicating a low confidence that the entries are related) with regard to being correlated with the Oct. 14, 2014 entry since none of the concepts expressed in the Nov. 15, 2014 entry relate to the Oct. 14, 2014 entry.

Groupings of one or more entries of this type may be made with regard to each entry in the document duration data structure 395 to generate confidence scores associated with each pairing or set of entries. Such grouping of entries may be done, for example, using a clustering approach or other grouping algorithm that identifies commonalities between the concepts associated with the entries. One or more thresholds may be pre-established for specifying a requisite score indicative of a correlation of entries in the document duration data structure 395. For example, a threshold may be set of 95% indicating that a 95% confidence score that the entries are related is required before the entries are determined to be related and correlated into a grouping of entries for purposes of an annotation generation operation.

For those entries that are determined to be sufficiently related to, and correlated with, one another such that they are grouped together, a duration is calculated by the implicit duration annotation logic 394 based on the dates/times associated with the correlated entries. The duration is associated with the matching concepts of the entries that are related and correlated with one another, or a combination of the concepts of the multiple entries. Thus, for example, in the above scenario, from the Oct. 14, 2014 and Oct. 21, 2014 entries in the document duration data structure 395, a duration of 7 days is generated by comparing the dates/times (e.g., subtracting the earlier date/time from the latter date/time). In one illustrative embodiment, this duration is associated with the concepts of “abdominal pain”, “laxative,” and “x-ray” which are the concepts that match between the two correlated entries. In other illustrative embodiments, a maximum set of concepts from the correlated entries is generated such that concepts that may not appear or match between the entries may also be listed, e.g., in the Oct. 21, 2014 entry, the concept of “results are negative” is also present but not in the Oct. 14, 2014 entry, but may be included in association with the duration calculation.

The calculated duration and its corresponding concepts are used to generate an annotation that is added to the metadata associated with the document(s) being processed. That is, the implicit duration annotation logic 394 generates an annotation that the logic 394 then inserts into the metadata of the document to thereby make explicit the implicit duration. This implicit duration may be set, for example, as the largest difference in date/time associated with entries in the grouping of entries. Of course other criteria for determining the implicit duration may also be used without departing from the spirit and scope of the illustrative embodiments. For example, a series of smaller durations in addition to a largest difference may be provided. The duration may be specified in many different formats utilizing different units of measure, e.g., days, weeks, months, years, etc. In some cases, the duration may be specified in association with start and end dates, years, etc., “from January 2014 to March 2014 (3 months) the patient suffered from abdominal pain” such that a temporal context for the duration may be made explicit in the annotation.

It should be appreciated that there may be an implicit duration created for each entry, or concept, to which another entry or concept is compared and this can result in multiple implicit durations for an entry or concept. For example, assume there are three sections in a document, each section corresponding to a different entry, and that each section has a date associated with it. Assume also that the dates are arranged in these sections from earliest to latest and that there are concepts that are in common between the sections. In such an example, there will be no implicit durations created in the first section as it is the earliest section and nothing is compared against the earliest section to generate an implicit duration leading up to this earliest section. However, there will be an implicit duration created for each concept in the second section that is common with the first section. Moreover, for the third section, for every concept that is in all three sections, there will be two implicit durations created as that concept would compare to both existing sections. For concepts that are only in common with one of the existing sections then only one implicit duration will be created. Thus, each of the second and third sections may have multiple implicit durations generated and stored in association with that section and/or the document as a whole.

It should be appreciated that if multiple documents are being correlated in this manner, annotations may be inserted into each of the documents or only a subset of the documents depending on the implementation. For example, a primary document (e.g., patient medical record document) may be designated which receives the duration annotations while other supporting documents (e.g., radiology report, lab results report, etc.) may not be augmented with the duration annotation. The designation of primary and secondary documentation may be specified in configuration parameters for the implicit duration annotation logic 394, for example, e.g., patient medical records are considered a primary document that is to be annotated while all other documents are considered secondary and will not be annotated.

As noted above, this process may be repeated for each document in the particular corpus/corpora 345, 347 that is utilized by the QA system pipeline 300 and may be done as part of a pre-processing or ingestion process. The resulting augmented corpus/corpora 345, 347 may then be used by the QA system pipeline 300 in a manner as previously described above to answer input questions 310 taking into account these calculated durations. In one illustrative embodiment, this may involve the comparison of durations in policies, rules, or other logic statements with the implicit durations within the documents that are now made explicit by way of the implicit duration engine 390 providing annotations to these documents in the corpus/corpora 345, 347. One example mechanism that may be utilized for comparing durations and determining similarities of durations is described in commonly assigned and co-pending U.S. patent application Ser. No. 14/183,701 entitled “NLP Duration and Duration Range Comparison Methodology Using Similarity Weighting,” filed on Feb. 19, 2014, which is hereby incorporated by reference.

For simplicity of the present explanation, this functionality for comparing durations of policies with durations in annotations is shown as being part of the implicit duration engine 390, but may be integrated into the logic of the various stages of the QA system pipeline 300 without departing from the spirit and scope of the illustrative embodiments. The implicit duration comparison logic 396 compares the implicit durations that are explicitly stated in the annotations of the documents considered for generation of answers to the input question 310, or documents that provide supporting evidence for candidate answers generated by the QA system pipeline 300, to determine whether one or more policies in the policy database 398 (which in this example case is a medical policy database) are triggered by the implicit durations. As described in the incorporated co-pending U.S. patent application Ser. No. 14/183,701, this may involve determining a similarity of durations and generating a similarity score which may be compared to a threshold to determine if there is a match.

Based on whether a policy is triggered by a matching implicit duration specified in the annotations of the document, a result is returned to one or more of the stages of the QA system pipeline 300, e.g., stages 340 or 350, to affect the confidence scores associated with the candidate answers generated by the QA system pipeline 300, add additional evidence in support of or against a particular candidate answer, or simply offer additional information to be presented along with the candidate answers when presenting them to the original submitter of the input question 310. For example, in one illustrative embodiment, if a candidate answer is generated that has a particular confidence score associated with it, but the implicit duration does not match, then the confidence score for the candidate answer may be reset to zero, e.g., if it is determined that in general a MRI would be recommended, but the patient has not yet been receiving drug X for 3 weeks, then the candidate answer of sending the patient to get an MRI will have its confidence score reduced to zero. Other ways in which to adjust candidate answer scoring may be to increase/decrease the candidate score, without setting it to zero, based on the duration matching or not matching, e.g., an MRI as a candidate answer may have its confidence score reduced, but not set to zero, when the durations do not match, or if the difference in durations is less than a particular threshold amount, e.g., the required duration is 3 weeks, but the patient has only been on drug X for 2.5 weeks, then the candidate answer score for the MRI may be reduced, but not set to zero. The amount of the reduction may correspond to the amount of difference between the implied duration and the duration requirements, for example.

Thus, the illustrative embodiments provide mechanisms for making implicit durations in documents more explicit such that they may be used as a basis for performing knowledge system operations. In particular, in the illustrative embodiments, this allows the mechanisms of the illustrative embodiments to determine if pre-established duration based policies are triggered based on implicit durations in documentation. Based on this triggering of policies, modifications to the results returned to a user may be made to take into consideration the policies that are triggered, e.g., a treatment may be recommended to a patient, medical professional, or the like, for a particular medical condition based on the triggering of a policy by an implicit duration identified in medical documents associated with the patient. As a result, policy based decisions, question answer, and information retrieval based on implicit durations is facilitated.

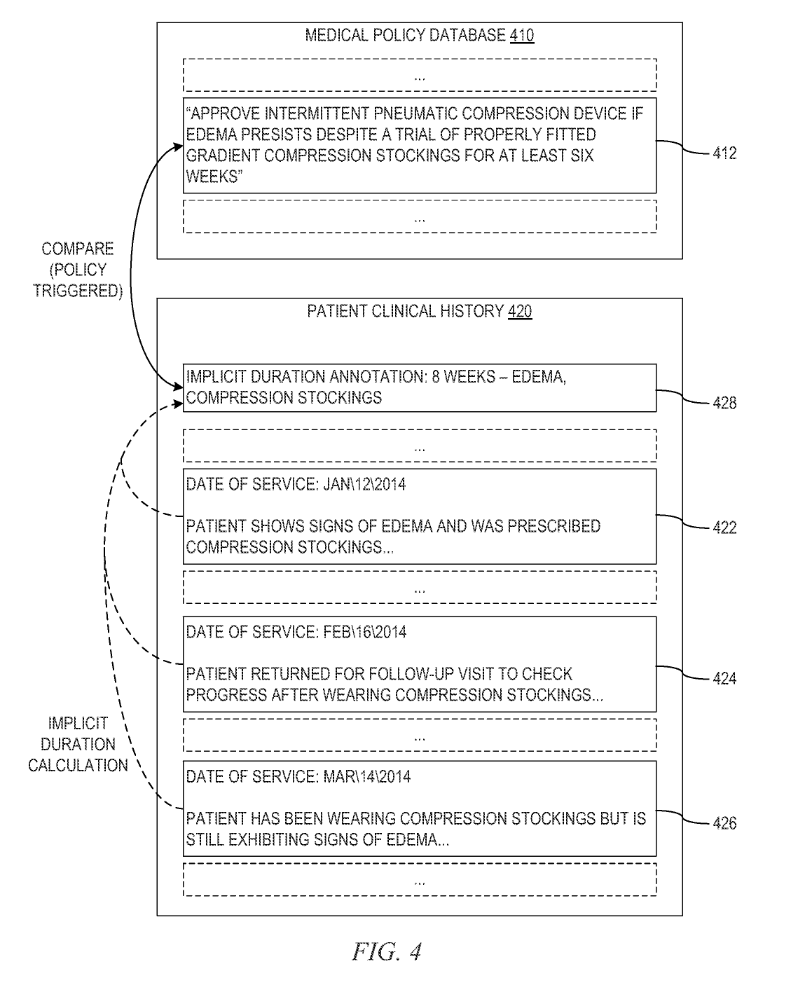

To further illustrate the operation of the illustrative embodiments in the context of a medical domain, consider the example shown in FIG. 4. FIG. 4 shows an example medical policy and patient clinical history, as may be provided in an electronic patient medical record for example, in accordance with one illustrative embodiment. As shown in FIG. 4, the medical policy database 410 comprises a plurality of medical policies directed to the approval/denial of particular medical equipment and procedures. Such a medical policy database 410 may comprise medical policies of one or more health insurance agencies and may specify the types of devices, treatments, medical procedures, and the like, that the health insurance agencies approve/deny and the conditions of approval/denial, for example. In the depicted example, one such medical policy is a medical policy 412 that indicates that a health insurance professional should “Approve intermittent pneumatic compression device if edema persists despite a trial of properly fitted gradient compression stockings for at least six weeks.”

In addition, as shown in FIG. 4, the patient clinical history 420 includes entries 422, 424, and 426 for various service dates when a medical professional attended to the patient. These entries 422-426 include dates of service and corresponding text representing clinical notes describing the service provided, medical conditions present, or with which the patient was diagnosed, and other information regarding the medical situation of the patient at the time of service.

Assume that a physician wishes to prescribe to the patient an intermittent pneumatic compression device and submits to the QA system an input question of the type “Is the patient approved for use of an intermittent pneumatic compression device?” The QA system may analyze and decompose the question in the manner previously described and, as part of the candidate answer generation, utilize the implicit duration engine of the illustrative embodiments to determine if there is a medical policy in the medical policy database 410 that is triggered by the implicit durations indicated in the patient's clinical history 420 (which operates as a document from the corpus). Prior to utilizing the implicit duration, however, the mechanisms of the illustrative embodiments annotate the patient's clinical history 420 with annotations 428 specifying the implicit durations in the patient's clinical history 420 explicitly.

For example, looking at the various service entries 422-426, it can be seen that three entries are made in the patient's clinical history 420 that have related concepts of “compression stockings” and “edema”. Grouping or otherwise correlating these entries 422-426, an annotation 428 is generated that indicates that there is an implicit duration of two months (8 weeks or 61 days) between service visits and the patient is still undergoing the same treatment with compression stockings and is still exhibiting issues with edema.

When answering the input question from the physician, the annotation 428 is compared to the medical policies in the medical policy database 410, which may also serve as a portion of the corpus upon which the QA system operates, to thereby identify the medical policy 412 which relates to edema and compression stockings. This identification of a policy 412 in the medical policy database 410 may be performed using natural language processing and evaluation of the corpus 347, of which the database 410 may be a part, in a manner as discussed above. Thus, applying queries against the medical policy database 410, the QA system may identify the medical policy 412 as being pertinent to the question that mentions the concepts of “edema” and an “intermittent pneumatic compression device.” Comparing the implicit duration annotation 428 of the patient clinical history 420 to the criteria of the medical policy 412, it is clear that the implicit duration associated with the time lapse between Jan. 12, 2014 and Mar. 14, 2014 meets or exceeds the “at least six weeks” requirement for the use of gradient compression stockings, and thus, approval of the prescribing of the “intermittent pneumatic compression device” is warranted. It should be noted that if the last entry 426 were not present in the patient's clinical history 420, then the implicit duration that would result from analysis of the patient's clinical history 420 would not meet the requirements of the medical policy 412 since the patient would only have been using the compression stockings for approximately four weeks.

Since implied durations may change over time, the annotation mechanisms may be utilized on a periodic (scheduled) or continuous basis. Moreover, the annotation mechanisms may operate in response to predetermined events, e.g., updates to the corpus, user request to initiate annotation operations, or the like. With regard to event based operations, the annotation operations may be focused on those portions of the corpus that have changed since a last execution of the annotation logic on the corpus, for example, e.g., only operating on the patient medical records that have changed since a last annotation operation. Thus, the documents in the corpus are maintained with a most up-to-date version of the implicit duration annotations as possible to ensure proper answering of questions by the QA system.

It should be apparent to those of ordinary skill in the art that although the illustrative embodiments are described in the context of the medical domain with operations being performed on patient medical records and evaluating medical policies, the invention is not limited to such. Rather, the mechanisms of the illustrative embodiments are applicable to any domain where date/time based entries are utilized and implicit durations may be important to decision making, information reporting, or question answering. Just as one other example, the mechanisms of the illustrative embodiments may be used with regard to automotive repair where records are maintained of services performed on an automobile at various times and decisions may need to be made or questions may need to be answered regarding services to perform or provide to an owner of the automobile based on duration based policies. In such a domain, the automotive repair/service records may have entries with associated dates/times but may not explicitly indicate durations. As such, the mechanisms of the illustrative embodiments may be utilized to annotate such automotive repair/service records with implicit duration annotations that can then be used to evaluate against automotive repair/service policies of an automotive insurance company, automobile manufacturer, governmental organization governing the particular type of automobile or service offered using the automobile (e.g., the trucking industry), or the like. Of course other domains where the mechanisms of the illustrative embodiments may be implemented will become apparent to those of ordinary skill in the art in view of the present description.

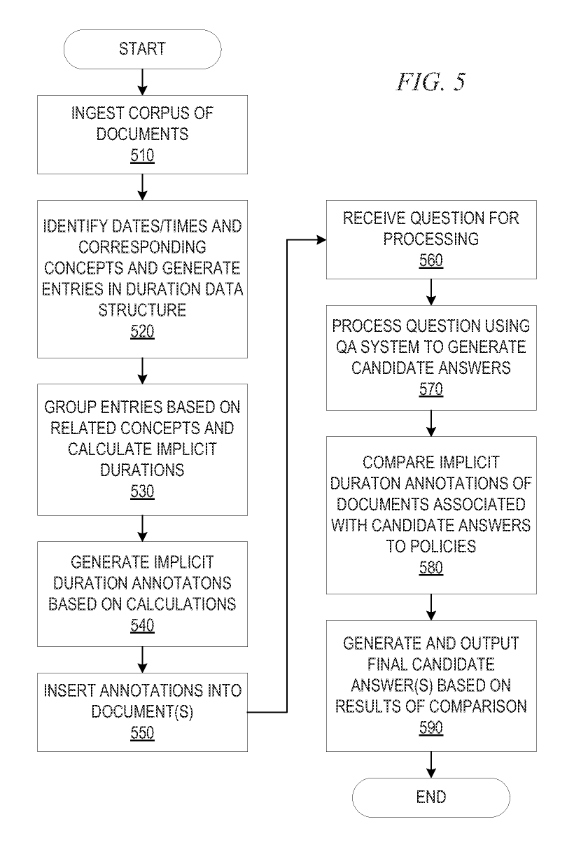

FIG. 5 is a flowchart outlining an example operation of a QA system implementing an implicit duration annotation mechanism in accordance with one illustrative embodiment. As shown in FIG. 5, the operation initially starts with the ingestion of a corpus of documents (step 510). As part of the ingestion operation, for each document or subset of related documents, dates/times associated with, or identified in, the documents are identified along with the corresponding concepts to generate entries in a document duration data structure (step 520). Entries in the document duration data structure are grouped according to related concepts and one or more implicit durations associated with the group are calculated (step 530). One or more annotations corresponding to the implicit duration are generated which correlates the one or more implicit durations with corresponding concepts (step 540). These annotations are inserted into the documents of the group, or into a primary document of the group (step 550).

At some point later, a question is received for processing by the QA system (step 560). The question is processed by the QA system to generate queries that applied to the annotated corpus (step 570). The implicit duration annotations of documents found as a result of the queries, i.e. that provide candidate answers or support for candidate answers, are compared against one or more duration-based policies of a policies database (which may itself be part of the corpus) (step 580). Based on the comparison of the implicit duration annotations with the duration-based policies, one or more final candidate answers are generated and returned for output to the submitter of the question (step 590). The operation then terminates.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1-10. (canceled)

11. A computer program product comprising a computer readable storage medium having a computer readable program stored therein, wherein the computer readable program, when executed on a data processing system, causes the data processing system to:
receive at least one document having a plurality of associated dates and/or times and concepts associated with the dates and/or times, wherein the at least one document does not explicitly specify a duration between the dates and/or times;
correlate dates and/or times in the at least one document having similar associated concepts;
calculate, for the correlated dates and/or times, an implicit duration based on the dates and/or times;
associate the associated concepts with the implicit duration;
annotate a first document in the at least one document with an implicit duration annotation that specifies the implicit duration and the associated concepts; and
perform the duration-based operation based on the implicit duration annotation.

12. The computer program product of claim 11, wherein the computer readable program further causes the data processing system to:
analyze the at least one document to identify the dates and/or times; and
perform natural language processing to identify textual content corresponding to concepts associated with the dates and/or times identified in the at least one document.

13. The computer program product of claim 12, wherein the computer readable program further causes the data processing system to perform natural language processing to identify textual content corresponding to concepts associated with the dates and/or times at least by identifying keywords or phrases within a predetermined textual range of the dates and/or times.

14. The computer program product of claim 11, wherein the computer readable program further causes the data processing system to calculate an implicit duration based on the dates and/or times at least by, for each portion of a plurality of portions of the at least one document associated with a date and/or time, calculate one or more implicit durations based on a comparison of a date and/or time associated with the portion to a date and/or time of another portion of the at least one document.

15. The computer program product of claim 11, wherein the computer readable program further causes the data processing system to calculate an implicit duration based on the dates and/or times at least by:
clustering portions of the at least one document based on similarity of concepts in the portions of the at least one document; and
calculating at least one implicit duration for each cluster generated by the clustering based on a comparison of dates and/or times associated with the portions of the at least one document associated with the cluster.

16. The computer program product of claim 15, wherein the at least one implicit duration for each cluster is calculated to be a largest difference in date and/or time between dates and/or times associated with the portions of the at least one document associated with the cluster.

17. The computer program product of claim 11, wherein the first document is a document specified through configuration of the data processing system to be a primary document type, and wherein other documents in the at least one document that are not designated to be the primary document type are not annotated.

18. The computer program product of claim 11, wherein the data processing system is a Question Answering (QA) system, and wherein performing the duration-based operation based on the implicit duration annotation comprises generating an answer to an input question based on the implicit duration annotation.

19. The computer program product of claim 18, wherein the duration-based operation further comprises modifying scoring of one or more candidate answers for the input question based on a correspondence between the implicit duration specified in the implicit duration annotation and one or more duration criteria associated with the one or more candidate answers.

20. The computer program product of claim 11, wherein the at least one document comprises a patient medical record, and wherein performing the duration-based operation comprises generating and outputting a treatment recommendation for a patient corresponding to the patient medical record based on a comparison of the implicit duration to duration requirements in one or more medical treatment policies.

21. An apparatus comprising:
a processor; and
a memory coupled to the processor, wherein the memory comprises instructions which, when executed by the processor, cause the processor to:
receive at least one document having a plurality of associated dates and/or times and concepts associated with the dates and/or times, wherein the at least one document does not explicitly specify a duration between the dates and/or times;
correlate dates and/or times in the at least one document having similar associated concepts;
calculate, for the correlated dates and/or times, an implicit duration based on the dates and/or times;
associate the associated concepts with the implicit duration;
annotate a first document in the at least one document with an implicit duration annotation that specifies the implicit duration and the associated concepts; and
perform the duration-based operation based on the implicit duration annotation.
